(19) United States
(12) Patent Application Publication
(10) Pub. No.: US 2007/0160832 A1
(43) Pub. Date: Jul. 12, 2007

(54) LAMINATE FILM HAVING OPTICAL BRIGHTENER

(75) Inventors: Anne E. Herrmann, Loveland, OH (US); Yubo Huang, Lombard, IL (US)

Correspondence Address: MICHAEL BEST & FRIEDRICH, LLP, 100 E WISCONSIN AVENUE, Suite 3300, MILWAUKEE, WI, 53202, US

(73) Assignee: GENERAL BINDING CORPORATION, Northbrook, IL (US)

(21) Appl. No.: 11/459,421

(22) Filed: Jul. 24, 2006

Related U.S. Application Data
(60) Provisional application No. 60/702,045, filed on Jul. 22, 2005.

(51) Int. Cl. B32B 15/04; B32B 7/12

(52) U.S. Cl. 428/343; 428/355 R

(57) ABSTRACT

A thermal laminating film includes a substrate layer and a thermally-activated adhesive layer. A full spectrum optical brightener is coupled with at least one of the substrate layer and the adhesive layer to counteract any coloration present in the substrate and/or adhesive and reduce color shift for colors displayed on the sheet material or other object laminated with the film.

### RELATED APPLICATIONS

This application claims priority to U.S. Provisional Patent Application No. 60/702,045 filed Jul. 22, 2005, the entire content of which is hereby incorporated by reference.

### FIELD OF THE INVENTION

The invention pertains to a laminate film having an optical brightener, and more specifically, a laminate film having a substantially full-spectrum optical brightener disposed within the adhesive of the laminate film.

### BACKGROUND OF THE INVENTION

Laminate films are known in the art. They are used to laminate objects, such as paper documents, identification cards, etc., for protection and visual enhancement of the object. The films typically comprise a layer of adhesive on one side of the film that permits the film to be adhered to the object. When laminating the object, the film is disposed such that the adhesive layer is adjacent to the object and the adhesive is activated, either via pressure or heat, to adhere the film to the object. Thus, the underlying object is protected by the film disposed thereon.

Oftentimes, the film and adhesive combination may not be entirely clear, but instead may be a shade of a particular color (typically yellow). For films incorporating a thermal adhesive, this yellowing effect may be due to thermal degradation of the adhesive which occurred during the manufacturing process. Other sources of discoloration include ultraviolet light degradation and additives. Nearly all thermal laminating films have some yellow color to them. This color is undesirable for many applications because the coloration in the film can alter the appearance, or shift the color of the underlying object toward the yellow portion of the visible spectrum. This is particularly evident when viewing white through the film. Therefore, additives may be utilized within the film substrate to counteract this yellow or other color shift. These additives may be referred to as optical brighteners, fluorescing agents, or whitening agents. Current additives usually reflect, fluoresce or emit light in the blue portion of the visible spectrum and absorb other colors of light. Although these types of additives have a whitening effect that helps to counteract any color of the film, only light in the blue portion of the visible spectrum is significantly reflected, fluoresced or emitted. Thus, there is a color shift towards the blue portion of the visible spectrum for other colors displayed on the underlying object when viewed through the film. For example, the color yellow on the underlying object may appear green when the film substrate has this type of optical brightener.

Films utilizing a pressure-sensitive adhesive are known in the art. Pressure-sensitive laminating films are useful when the object or a part of the lamination film is sensitive to heat. Pressure-sensitive laminating films have been known to incorporate optical brighteners, including full spectrum optical brighteners sold under the name PRELUME®. However, pressure-sensitive films tend to be rather expensive as they are generally at least twice the cost of thermal adhesives and generally require a release liner which is disposed of during the lamination process. Additionally, the adhesive layer and the substrate or carrier layer are relatively thick, increasing the cost of these films. Further, the lamination process itself is generally slow with pressure-sensitive films, ranging from 3 to 10 feet per minute in many cases. Thermal films are advantageous in that the adhesives used are generally lower cost, constructions are not as thick, they do not require a release liner (as the adhesive is not tacky at room temperatures), and thus are typically less expensive than pressure-sensitive films. Additionally, thermal films allow faster lamination processing, ranging from 5 to 150 or more feet per minute. However, films having a thermal adhesive must be heated to a threshold temperature in order to activate the thermal adhesive during lamination. Further, the adhesive itself is typically melted during the process of producing the laminating film.

Accordingly, it is desirable to provide thermal laminating films that prevent or minimize undesirable color shifting and provide nearly accurate or enhanced color transmission through the film. It is further desirable that such films may be utilized in conventional application systems.

### BRIEF SUMMARY OF THE INVENTION

The invention provides a thermal laminating film for laminating an object, such as a sheet of paper, where the film comprises a substrate layer and a thermally activated adhesive layer wherein an optical brightener is disposed within the substrate and/or the adhesive to counteract any coloration (such as yellow) present in the substrate and/or adhesive. The optical brightener reduces apparent color shift for any colors displayed on the object laminated with the film. The optical brightener is substantially a full spectrum brightener, such that the brightener itself does not introduce a color shift to a particular portion of the visible spectrum (to the blue portion, for example). In addition to counteracting any particular coloration in the laminate film, the optical brightener may enhance any colors displayed on the underlying object when viewed through the laminate film.

### BRIEF DESCRIPTION OF THE DRAWINGS

FIG. 1 is a perspective view of a sheet material that has been laminated with a laminate film;

FIG. 2 is an enlarged fragmentary side cross-sectional view taken along line 2-2 of the sheet material and laminate film of FIG. 1; and

FIG. 3 is an enlarged fragmentary side cross-sectional view of another sheet material and laminate film.

### DETAILED DESCRIPTION OF THE INVENTION

Laminate films have a structure that protects and/or visually enhances an object such as a sheet material (often a sheet of paper). In addition to the object itself, the laminate film also protects and/or enhances any image displayed or printed matter disposed on the object. Such films protect the sheet material because the films prevent direct exposure of the sheet material to external elements. Further, laminate films may be constructed of a material that is relatively more durable than the sheet material itself.

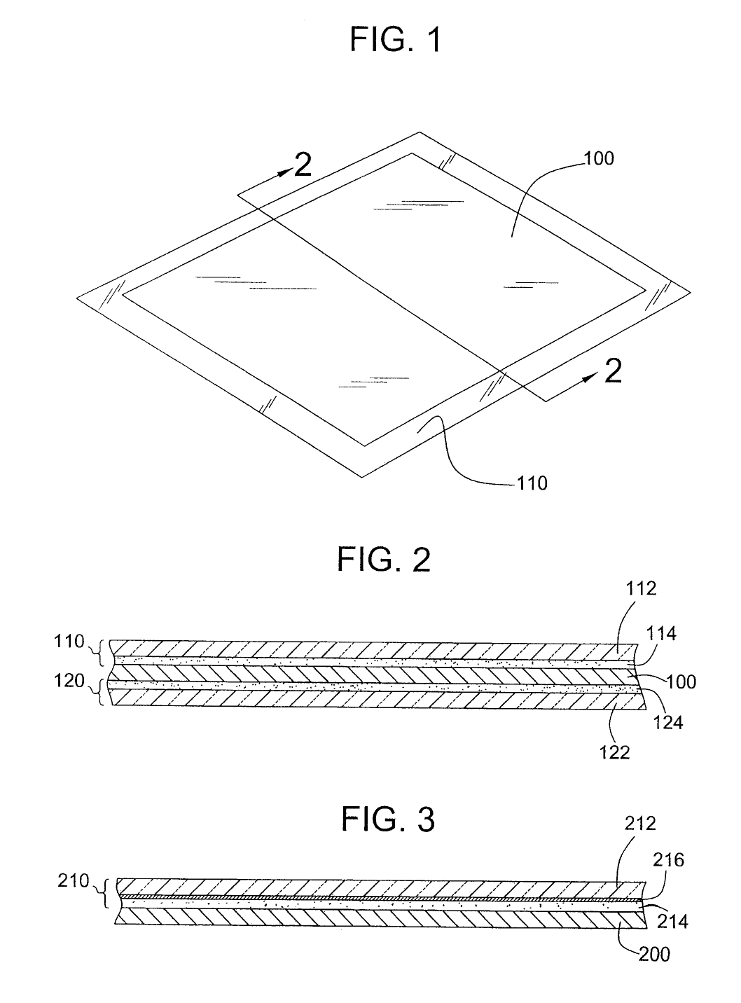

Referring to FIG. 1, there is shown a laminate film 110 disposed over a sheet material 100. The film 110 may be disposed such that it covers all or only a portion of a side of the sheet material 100. Additionally, as shown, the film 110 may extend beyond the sheet material 100 in one or more directions. It will be appreciated that laminate film 210 may be disposed over only one side of the sheet material 200, as shown in FIG. 3, or such films 110, 120 may be disposed over both sides of the sheet material 100, as shown in FIG. 2 (both arrangements are discussed in greater detail below). The laminate film 110 may be relatively rigid or it may have a structure that permits it to conform to the shape of the object to which it is adhered.

The laminate film 110 has a structure that permits it to adhere to the object it is protecting and/or enhancing. Referring to FIG. 2, there is shown a cross-sectional view of the sheet material 100 having a first laminate film 110 disposed on a first side of the sheet material 100 and a second laminate film 120 disposed on a second side of the sheet material 100. The laminate film 110, 120 may comprise a substrate layer 112, 122 and an adhesive layer 114, 124. Both layers are substantially transparent such that light may pass through the laminate film 110, 120 and the sheet material 100 may be viewed through the film 110, 120. The substrate layer 112, 122 provides strength to the film 110, 120 and is disposed closer to the viewer. The adhesive layer 114, 124 is disposed on one side of the substrate layer 112, 122 such that when the film 110, 120 is adhered to an object, the adhesive 114, 124 is disposed between the substrate layer 112, 122 and the sheet material 100 to bind the film 110, 120 to the sheet material 100. As shown in FIG. 3, the laminate film 210 may alternately be disposed over a single side of the sheet material 200. The laminate film 110, 120 may be applied to the sheet material 100 by hand or through the use of a laminating machine.

With some embodiments of thermal lamination films such as the embodiment shown in FIG. 3, the adhesive layer 214 may not bond to the substrate layer 212 prior to thermal activation of the adhesive 214 during a thermal lamination process. In order to enhance the bond between the substrate and adhesive layers 212, 214 prior to laminating a sheet material 200, an adhesion promoter 216 may be provided between the substrate layer 212 and the adhesive layer 214. While the adhesion promoter 216 may be applied to the substrate 212 prior to application of the adhesive layer 214, the adhesion promoter 216 may alternately be applied to the substrate 212 concurrently with the application of the adhesive layer 214. Examples of adhesion promoters 216 include, but are not limited to, corona treatment, plasma treatment, flame treatment, a tie layer, a primer, or any combination thereof. While an adhesion promoter 216 has been illustrated in connection with a film 210 applied to a single side of a sheet material 200, such an adhesion promoter may be included in films 110, 120 applied to both sides of a sheet material 100, such as the embodiment illustrated in FIG. 2.

The substrate layer of the film may be constructed of any suitable material, including, but not limited to polyolefins, nylon, polyester, acetate, polyvinyl chloride, polycarbonate, polyvinylidene chloride, or any combination thereof. Any of the substrates may be oriented in one or more directions to augment certain properties, such as tensile strength. The substrate may include additives to change the properties of the base material, such as coefficient of friction or UV light stability. Additionally, the substrate may be a composite or mixture of one or more materials.

The adhesive layer of a thermal laminating film comprises a thermally activated adhesive. Examples of suitable thermal adhesives include, but are not limited to, ethylene vinyl acetate copolymer (EVA), ethylene ethyl-acetate copolymer (EEA), polyethylene, polyvinyl alcohol, ethylene methyl acrylate copolymer, ethylene methyl methacrylate copolymer, or blends of one or more of the above materials. Additionally, the adhesive may have various additives to increase tack (i.e. a tackifier), modify the flow properties of the adhesive, promote adhesion to certain types of objects, and/or aid processing (such as an antioxidant).

In addition to providing protection to the sheet material, the laminate film may also enhance the appearance of the sheet material and any image/printed matter displayed thereon. For example, the substrate layer of the laminate film may have a glossy appearance that enhances the appearance of the sheet material. It may have a matte finish, a texture, an embossed image or any combination thereof.

Enhancement may also be achieved through color manipulation. Laminate films often have a tendency to reflect a particular color of light, such as yellow. Therefore, when a sheet material is viewed through the laminate film, the color in the film affects the colors on the sheet material viewed through the film. This is particularly apparent when the color white is displayed on the sheet material. In accordance with teachings of the invention, to counteract any dominant color reflected by the laminate film itself and/or enhance the colors viewed through the laminate film, an optical brightener may be incorporated into the substrate layer and/or the adhesive layer of the thermal laminating film. The optical brightener of the present invention reflects light in substantially the full visible spectrum rather than just a small portion of the visible spectrum. Therefore, substantially all of the colors displayed on the sheet material are enhanced when viewed through the laminate film without experiencing significant color shifting.

A presently preferred substantially full spectrum optical brightener is a modified benzoxazole (such as BBOT) and is a blend of several individual optical brighteners. Each individual brightener functions more specifically at different segments of a full spectrum. The PRELUME® family of optical brighteners includes an example of a suitable substantially full spectrum optical brightener that is commercially available from Utopia Digital Technologies, Inc of New Berlin, Wis. When mixed with the adhesive resin of the thermal laminating film, the full spectrum optical brightener should be between about 0.015% and about 0.150% by weight of the total amount of thermal laminating adhesive resin to achieve the optimum full spectrum brightening effect. In another embodiment, the full spectrum optical brightener should be between about 0.075% and about 0.150% by weight of the total amount of thermal laminating adhesive resin to achieve the optimum full spectrum brightening effect. These ranges have been found to work well in the thermally-activated adhesives used for thermal laminating films, and are not necessarily ranges that would be optimal in other applications, such as pressure-sensitive adhesives.

While it has been known to use of the PRELUME® family of optical brighteners in pressure-sensitive adhesives, adapting the use of the PRELUME® family of optical brighteners to thermally-activated adhesives has not been intuitive. Specifically, pressure-sensitive adhesives for pressure-sensitive laminating films are made by dissolving a polymer and other additives in a liquid solvent to yield a formulated liquid adhesive that is then coated onto the film substrate. The optical brightener additive, in solid form, is also dissolved in the liquid solvent for pressure-sensitive adhesives. Thermally-activated adhesives for thermal laminating films are supplied in solid form, typically solid pellets of formulated resin and additives. The solid pellets are formed by melt-blending the resin and the additives (including the full spectrum optical brightener). The formulated solid resin pellets are then placed in an extrusion machine, that melts the pellets and extrudes the melted adhesive onto the film substrate. Completely different techniques are required for manufacturing thermally-activated adhesives having a full spectrum optical brightener of the present invention than are required for manufacturing pressure-sensitive adhesives with a full spectrum optical brightener.

In certain instances, the addition of an ultraviolet (UV) absorbing or blocking additive to the adhesive layer and/or the substrate layer may also be desirable. For example, the optical brightener may emit too much light (and appear purple) and may degrade rapidly over time. The UV additive may be used to shield the optical brightener from full UV light exposure, reducing the purple emissions and protecting the optical brightener from degradation. Additionally, the UV absorber or blocker may also prevent or retard the degradation of the image and/or the adhesive caused by UV light. This UV absorbing or blocking additive further enhances the protective benefits of the laminating film. The UV additive may be any suitable UV additive that will not significantly inhibit the function of the full spectrum optical brightener including, but not limited to, a modified benzotriazole (such as octrizole). Such a UV additive is available in a product package with the PRELUME® family of optical brighteners from Utopia Digital Technologies, Inc. of New Berlin, Wis. The ratio of UV additive to the full spectrum optical brightener in the total additives added to the thermal laminating adhesive resin should be between about 1:1 and about 10:1. In one embodiment, the ratio of UV additive to the full spectrum optical brightener in the total additives added to the thermal laminating adhesive resin should be between about 1:1 and about 4:1. These ratios have been found to work well in the thermally-activated adhesives used for thermal laminating films, and are not necessarily ratios that would be optimal in other applications, such as pressure-sensitive adhesives. Specifically, it has been determined that due to the differences between the resins used to make thermally-activated adhesives and the polymers and solvents used to make pressure-sensitive adhesives, significantly more UV additive is required in thermally-activated adhesives than in pressure-sensitive adhesives to provide adequate UV blocking/absorption.

A first example formulation for a thermal laminating adhesive resin of the present invention is:

| Substance | Percent by weight |
|---|---|
| EVA copolymer | 99.625% |
| Full spectrum optical brightener | 0.075% |
| UV absorbing/blocking agent | 0.300% |

A second example formulation for a thermal laminating adhesive resin of the present invention is:

| Substance | Percent by weight |
|---|---|
| EVA copolymer | 99.700% |
| Full spectrum optical brightener | 0.150% |
| UV absorbing/blocking agent | 0.150% |

Although the laminate film is shown as disposed over a sheet material, the film may be used to laminate any suitable object. Accordingly, the laminate film may be any suitable size and/or shape. Furthermore, as mentioned above, the laminate film may be used to laminate a single side of an object or multiple sides of an object. Moreover, film including the full spectrum optical brightener may be provided in the same form, i.e., typically in flat sheets or on rolls, and utilized in the same manner as traditional laminating films, i.e., utilizing standard equipment.

Any references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Various features of the invention are set forth in the following claims.

1. A thermal laminating film comprising:
a substrate layer;
a thermally-activated adhesive layer coupled with the substrate layer; and
a full spectrum optical brightener coupled with at least one of the substrate layer and the adhesive layer.

2. The thermal laminating film of claim 1, wherein the full spectrum optical brightener is a modified benzoxazole.

3. The thermal laminating film of claim 1, wherein the full spectrum optical brightener is mixed with the adhesive layer.

4. The thermal laminating film of claim 3, wherein the full spectrum optical brightener is between about 0.015% and about 0.150% by weight of the adhesive layer.

5. The thermal laminating film of claim 4, wherein the full spectrum optical brightener is between about 0.075% and about 0.150% by weight of the adhesive layer.

6. The thermal laminating film of claim 1, further comprising an ultraviolet absorbing or blocking additive coupled with at least one of the substrate layer and the adhesive layer.

7. The thermal laminating film of claim 6, wherein the ultraviolet absorbing or blocking additive is mixed with the adhesive layer.

8. The thermal laminating film of claim 6, wherein the ratio of ultraviolet absorbing or blocking additive to the full spectrum optical brightener is between about 1:1 and about 10:1.

9. The thermal laminating film of claim 8, wherein the ratio of ultraviolet absorbing or blocking additive to the full spectrum optical brightener is between about 1:1 and about 4:1.

10. The thermal laminating film of claim 6, wherein the ultraviolet absorbing or blocking additive includes a modified benzotriazole.

11. The thermal laminating film of claim 1, wherein the full spectrum optical brightener is a blend of a plurality of optical brighteners.

12. A thermal laminating film comprising:
a substrate layer; and
a thermally-activated adhesive layer coupled with the substrate layer, the thermally-activated adhesive layer including between about 0.015% and about 0.150% by weight of a full spectrum optical brightener.

13. The thermal laminating film of claim 12, wherein the full spectrum optical brightener is a modified benzoxazole.

14. The thermal laminating film of claim 12, wherein the thermally-activated adhesive layer includes between about 0.075% and about 0.150% by weight of the full spectrum optical brightener.

15. The thermal laminating film of claim 12, wherein the thermally-activated adhesive layer further comprises an ultraviolet absorbing or blocking additive.

16. The thermal laminating film of claim 15, wherein the ultraviolet absorbing or blocking additive includes a modified benzotriazole.

17. The thermal laminating film of claim 15, wherein the ratio of ultraviolet absorbing or blocking additive to the full spectrum optical brightener is between about 1:1 and about 10:1.

18. The thermal laminating film of claim 17, wherein the ratio of ultraviolet absorbing or blocking additive to the full spectrum optical brightener is between about 1:1 and about 4:1.

19. The thermal laminating film of claim 11, wherein the thermally-activated adhesive layer includes about 99.625% by weight of ethylene vinyl acetate copolymer, about 0.075% by weight of the full spectrum optical brightener, and about 0.300% by weight of an ultraviolet absorbing or blocking additive.

20. The thermal laminating film of claim 11, wherein the thermally-activated adhesive layer includes about 99.700% by weight of ethylene vinyl acetate copolymer, about 0.150% by weight of the full spectrum optical brightener, and about 0.150% by weight of an ultraviolet absorbing or blocking additive.
